(19) United States
(12) Patent Application Publication
(10) Pub. No.: US 2011/0022837 A1
(43) Pub. Date: Jan. 27, 2011

(54) Method and Apparatus For Performing Secure Transactions Via An Insecure Computing and Communications Medium

(76) Inventor: William M. Stevens, Kirkland, WA (US)

Correspondence Address: William Stevens, 13236 NE 131st Place, Kirkland, WA, 98034, US

(21) Appl. No.: 12/838,992

(22) Filed: Jul. 19, 2010

Related U.S. Application Data
(60) Provisional application No. 61/271,213, filed on Jul. 18, 2009.

(51) Int. Cl. H04L 29/06; H04L 9/32

(52) U.S. Cl. 713/155; 726/5

(57) ABSTRACT

The present invention comprises a user interface hardware implementation and associated method for providing a means to achieve secure transactions between a human user and a remote computing facility or service, wherein the transaction is performed such that intermediate nodes, including the human user's primary computation device (e.g. personal computer, cellphone, etc.) need not be trustworthy while still preserving the privacy and authenticity of communications between the human user and remote computing facility or service.

### PRIORITY CLAIM

The present application claims benefit of priority under 35 U.S.C. 119(e) of provisional application No. 61/271,213 with filing date of Jul. 18, 2009.

### BACKGROUND

1. Technical Field

The present invention relates to electronic devices by which a user may perform transactions (e.g. financial, retail, medical, etc.) involving exchange of secret or personal information. This may include, but is not limited to, personal computers (desktop or laptop), cellular phones, personal digital assistants, tablet computing devices.

2. Description of Related Art

A plethora of methods and devices exist for the purpose of facilitating secure authentication and identification where said devices are used in conjunction with computing devices. Biometric readers, “smart card” readers, etc., are used to securely store and/or input personally identifiable or secret information for use in authentication and identification.

The Trusted Computing Group (TCG) specifies methods for securing a computing platform such that it can be trusted to perform its intended operation without risk from security compromise due to the effect of unknown intrusions and modifications to the computing system.

Trusted computing mechanisms also specify a hardware device known as a Trusted Platform Module which is essential to the implemented of Trusted Computing safeguards. TPM devices are capable of storing secrets and performing authentication in a manner which is resistant to tampering by intrusion or other forms of modification.

Smart card devices provide a mechanism for secure storage of secrets and for computation of authentication information, given appropriate input. When used in conjunction with appropriate software on an attached general computing device, smart card devices can provide strong authentication based on the user's physical possession of the smart card device.

### SUMMARY

The present art of security related to electronic transactions is rich with capabilities for establishing the identity of a user who is performing a transaction requiring strong assurance of identity and authenticity. These devices and methods, when used with general computing devices such as personal computers, cellphones, personal digital assistants, tablet devices, etc., provide utility in establishing the authenticity of the alleged identity of the user requesting the transaction being performed by the computing device.

What the present art does not provide, however, is a mechanism whereby two important factors of transaction security are ensured: Privacy of sensitive user information and strong assurance to the user of the absence of subversion of the integrity of the general computing device by means of intrusion (such as back-door software, trojan horse compromise, rootkit compromise, etc.). Though many techniques exist, and many attempts have been made to secure the general computing devices from such intrusion and tampering, the record is poor at succeeding in locking down such devices from intrusion. This leads to a climate in which many users are reluctant to utilize their general computing devices for the purpose of performing sensitive electronic transactions with other parties.

The most specific risk to a user's security is found in the simple fact that general computing devices provide the means for software executing on the device to alter the appearance of every display element (i.e. “pixel”) of the device's attached display. This leads to the inevitable conclusion that it is simply not possible for a user to trust such a device to be presenting accurate and authentic information via the display. Many examples exist of cases where the display image on a device has been carefully constructed to “spoof” the appearance of authentic information from trusted sources. Consequently a user is unwilling to trust anything displayed on such a device, no matter how authentic it may appear to be.

In addition to the risk a user faces when trusting what a device's display presents as trustworthy information, the user also faces risk of unintended disclosure of sensitive personal information entered via any of the input devices associated with a general computing device. As with subversion of the integrity of a device's display, it is also possible to capture any and all user input into a device. The most notorious of such mechanisms is the so called “key logging” technique, where a hidden software element records every keystroke entered on the key inputs of a device. This allows an intruder to learn sensitive information that the user intends to keep secret, such as passwords, personal identification codes (e.g. Social Security Number), and financial account numbers. Consequently, users are reluctant to trust any general computing device with regard to the safekeeping of any such information entered into the device's input mechanism.

Given these weaknesses and threats, the invention presented herein provides a means for a user to perform sensitive electronic transactions with a degree of trust (of the mechanisms used to perform said transactions) heretofor not possible. In a preferred embodiment, a device exists which incorporates a display and input mechanism dedicated to the purpose of performing the sensitive portions of a transaction in a manner which the user can trust to be authentic and not affected or monitored by untrusted entities. By providing purpose-specific isolation of the display, user input, and computing mechanisms (from those provided by an associated “general purpose” display, input, and computing mechanism), the said device provides the user with a secure means for interacting with the specifics of the transaction being undertaken.

In some embodiments it is possible to incorporate these purpose specific display, input, and computing mechanisms into a general purpose display, input and computing mechanism such that the combined device is capable of operating in a mode whereby the user can clearly distinguish that this (secure) mode is in operation, and trust that display and input operations associated with this (secure) mode are as trustworthy as they would be if said display, input, and computing mechanisms were physically separate from the general purpose computing device, as has been described in [0013] above.

All features and advantages of the present invention will become apparent in the following detailed written description.

### BRIEF DESCRIPTION OF THE DRAWINGS

FIG. 1 is a block diagram of a complete end to-end system depicting the elements involved in performing a secure transaction.

FIG. 2 is a graphic representation of a device implementing this invention, where the device is solely for the purpose of the authentication and identification application for which this invention is envisaged.

FIG. 3 is a graphic representation of a device implementing this invention, where the device is a multi-purpose device of which one of its functions is to perform the authentication and identification application for which this invention is envisaged.

FIG. 4 is a block diagram depicting the operational elements of a dice implementing this invention.

FIG. 5 is a diagram depicting the flow of messages among the elements depicted in FIG. 1, whereby one application of the invention is utilized to perform a secure transaction.

### DETAILED DESCRIPTION OF A PREFERRED EMBODIMENT

Overall Hardware Configuration

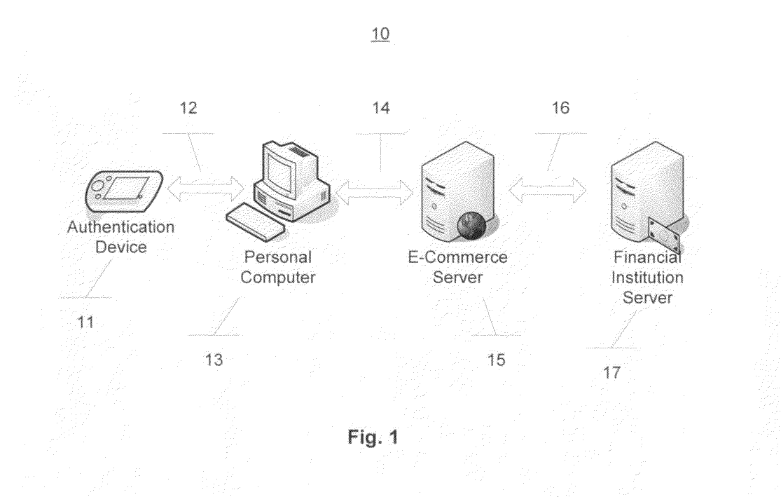

FIG. 1 is a block diagram of a complete end to-end system 10 depicting the elements involved in performing a secure transaction. An Authentication Device 11 is attached to a Personal Computer 13 via point-to-point communications medium 12. The Personal Computer 13 is attached to a public or private data network 14 by which the Personal Computer communicates with an E-commerce server 15. The E-Commerce server 15 may access the user's Financial Institution Server 17 via a public or private network 16. In some embodiments network 14 and network 16 may be the same network. In some embodiments network 14 and network 16 may be different networks.

The Authentication Device 11 is the device which is an embodiment of this invention. It provides the following component functions: a) Display of information pertaining to the operation being performed. This can include details of a financial transaction, e.g. a pending purchase from an online e-commerce merchant. b) Input of information by the operator of the Device via input mechanisms which are components of the Device through which said information may be entered. c) Computation of cryptographic identity vectors (e.g. secure hashes) and performance of encryption of plain text vectors into ciphertext, and the conjugate operation of decryption of ciphertext into plaintext vectors.

The application of cryptographic techniques as a component of the invention is fundamental to its utility, however the invention does not include any methods which advance the art of cryptography thereby. Standard cryptograplic techniques are utilized in manners which are obvious to one skilled in the art, so as to perform secure communications and identity/authentication techniques

In some applications, the operator of the device is asked to approve or deny a transaction. In other applications, the operator may be asked to input or verify sensitive information. In such applications, the Device is used to present said sensitive information, or provide the means for the operator of the Device to enter said sensitive information. In such applications, said sensitive information is never transmitted beyond the confines of the device in any form which would allow an unauthorized party to recover said information. Generally, said information will be transmitted to a remote party (e.g. a Financial Institution Server 17) in encrypted form, such that only the intended remote party is capable of recovering the sensitive information.

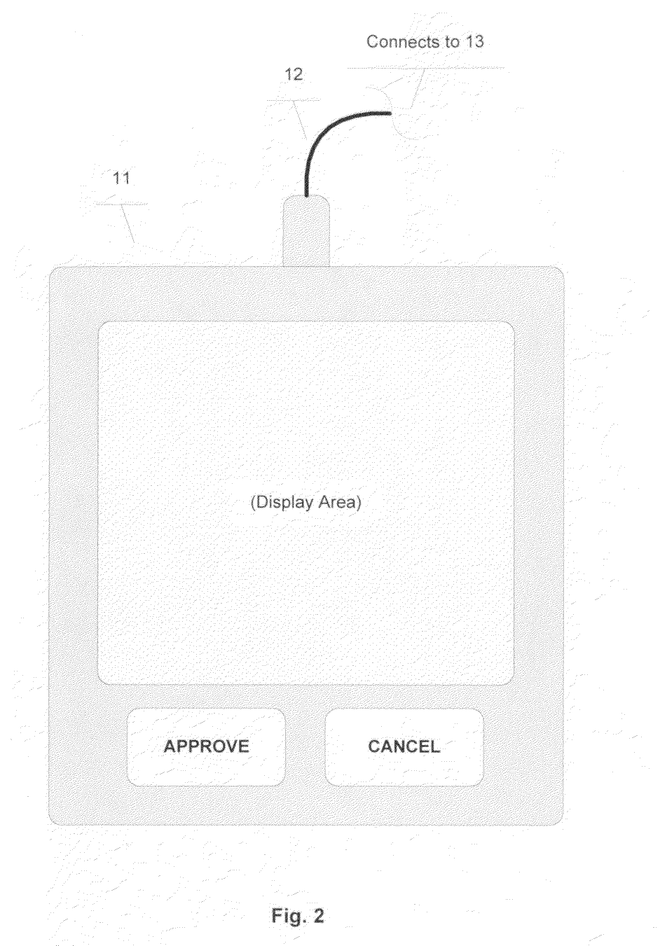

FIG. 2 is a graphic depiction of one embodiment of the Authentication device, where the embodiment consists of a dedicated device whose sole function is the authentication and identification function of this invention. The display and key input of the device are used only for authentication and identification purposes.

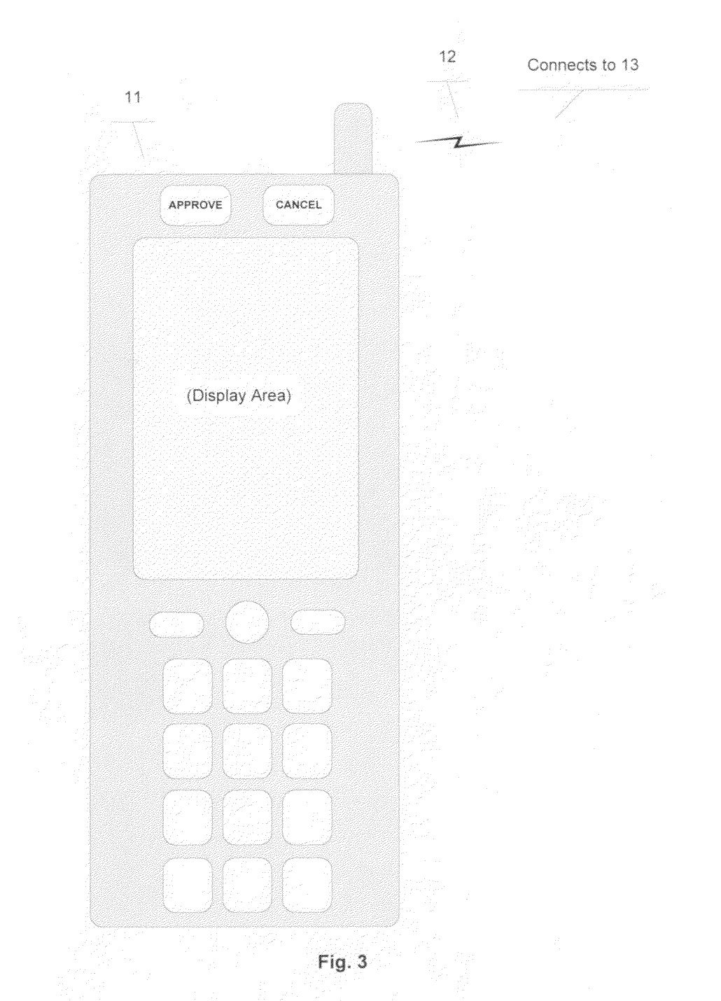

FIG. 3 is a graphic depiction of one embodiment of the Authentication device, where the embodiment consists of a multi-purpose device whose primary function is other than the authentication and identification function of this invention. In this embodiment, the display area is shared between the device's primary function and the authentication and identification function of this invention. Two dedicated input buttons (labeled Approve and Cancel) are provided by which the authentication function of this invention is operated.

FIG. 2 and FIG. 3 are illustrative examples of embodiments of the device which is the subject of this invention. However, many variations of the device are possible; the inclusion of FIG. 2 and FIG. 3 are not intended to constrain the applicability of the invention to these particular forms.

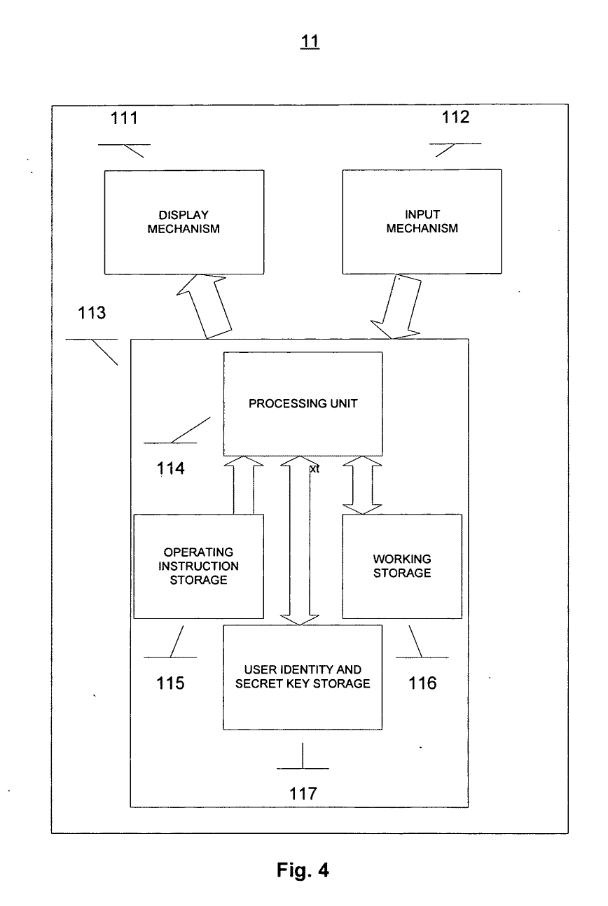

FIG. 4 is a diagram depicting the flow of messages among the elements depicted in FIG. 1, whereby one application of the invention is utilized to perform a secure transaction. This application is illustrative of one use of the Device in performing secure transactions via insecure computing and communication facilities, but the application of the Device is not restricted to just this application. Many similar applications may be effected through the use of well established cryptographic methods and communications protocols.

The elements depicted in FIG. 4 comprise the primary functional elements of the device which is the subject of this invention. Of particular note is the element 113 and its component parts 114, 115, 116, and 117, which are described in the following paragraphs.

Element 114 comprises a dedicated computational processing unit which is used to perform all operations internal to the device. Note that in this context, the word “device” is used to denote all elements of a device whose sole purpose is performance of the functions of this invention (such as is depicted in FIG. 2), or alternatively, “device” is used to denote those functions depicted in FIG. 4, where the depicted functions are subcomponents of a more general purpose device (such as is depicted in FIG. 3). If the “device” is a sub-component of a more general purpose device (such as is depicted in FIG. 3), then element 114 is also a sub-component of the more general purpose device, and the more general purpose device of which it is a component will likely incorporate another computational processing unit which is not utilized for the functions of this invention, and said additional computational processing unit is prohibited from direct access to any of the subcomponents of element 113. The design of this invention is such that elements 115, 116, and 117 are accessible only by the dedicated computational processing unit 114. Such isolation of access to elements 115, 116, and 117 are fundamental to the value of the invention.

Element 115 is a random access memory block which is non-volatile in nature. It stores the operating instructions by which element 114 performs the operations of the device. Modification of the contents of element 115 are restricted by design to only the manufacturer d the device, or entities explicitly authorized to modify said memory by the manufacturer. In some embodiments, such restriction is implemented by the initial operating instruction storage (as delivered by the manufacturer) such that any post-manufacture modification of the operating instruction storage can only be performed by element 114, and only upon presentation of a new memory image which is cryptographically protected from alteration, and cryptographically signed such that the origin of the new memory image can be authenticated by element 114 as being from the original manufacturer, or a duly authorized third party (where such authorization is effected by computing a cryptographic hash across the new memory image and comparing it to a second cryptographic hash stored in the new memory image, along with a public key digital certificate used to validate a cryptographic signature of the cryptographic hash stored with the new memory image). For such purposes, it is also necessary that an intrinsically trusted public key is stored in element 115 at time of manufacture, such that this trusted public key may be utilized to verify the signature of a digital certificate presented as a component of the new memory image.

Element 116 is a random access memory block which is volatile in nature, and for which no restrictions are imposed on reading or writing of said memory, except that any such reading or writing is possible only by the actions of element 114. This memory serves as “scratchpad”, or working, memory for element 114.

Element 117 is a random access memory block which is non-volatile in nature, and for which no restrictions are imposed on reading or writing of said memory, except that any such reading or writing is possible only by the actions of element 114. This memory serves as secure storage of secret information associated with the device and its legitimate user. Such secret information includes (but is not necessarily limited to): a) A secret key—typically a private key of a public/private key pair, which serves to authenticate the device as being that which is claimed (by the device) during secure protocol sessions with other parties; b) A public key certificate which contains the conjugate key to the secret key described in a); c) A device identification string which uniquely identifies this device among all such manufactured devices; d) a user identification string which uniquely identifies the owner and user of this device; e) other identifying and authentication information which may be needed in the performance of a particular application of the device.

The information stored in element 117 is used to perform identification and authentication functions when the device is communicating with other parties, so as to perform the operations for which the device is provided to its owner/user. The precise nature of such operations are not elaborated in this description, as they employ standard cryptographic techniques which are well established in the cryptographic art and well known to those skilled in the art. No claims are made in this invention as to the uniqueness of design or use of such cryptographic techniques.

Elements 111 and 112 are the display and input mechanisms which are components b the device, as described in paragraph [0022].

One application of the device is described in the following paragraphs. Many additional applications are possible using the capabilities and functions of the device; this application is exemplary of one such application.

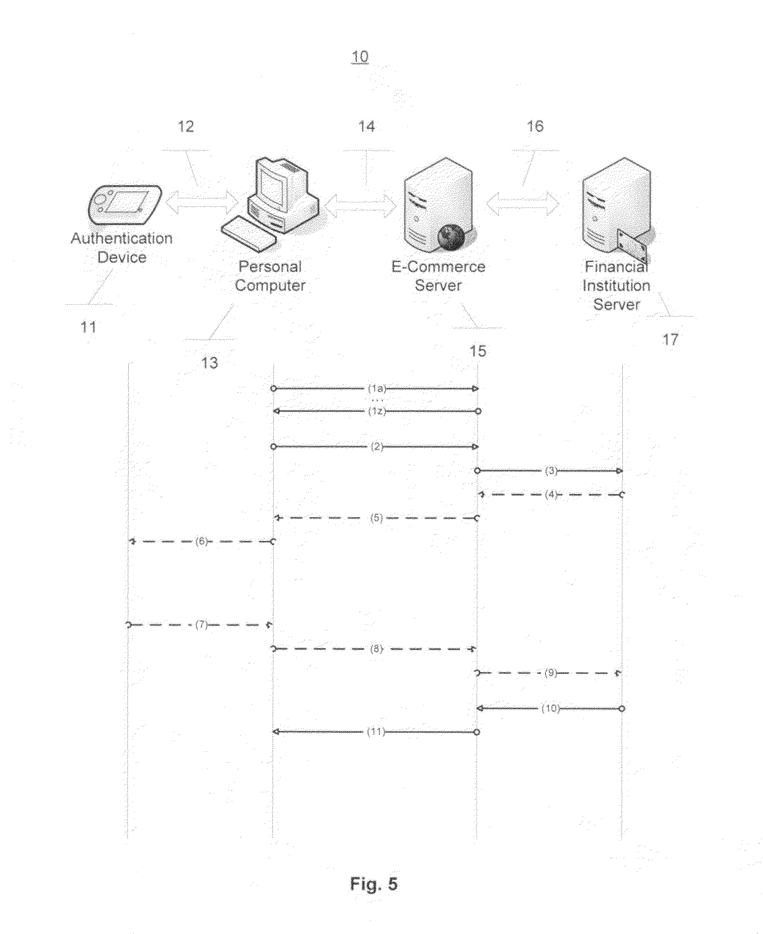

FIG. 5 depicts a typical electronic transaction effected between a user of a personal computer 13 and an e-commerce server 15. The device 11 connects to the personal computer 13 via some form of point-to-point communications 12. In some embodiments this may take the form of a USB cable, whereby the device 11 communicates with the personal computer 13, and additionally obtains operating power from the personal computer. In some embodiments this may take the form of a wireless connection, e.g. Bluetooth RF, whereby the device 11 communicates with the personal computer 13. In such embodiments, the device is either powered from an internal source (battery) or by some externally provided power source (AC Mains power).

The personal computer 13 communicates with an e-commerce server 15 via some public or private network facility. In some embodiments the Internet is used for such communications. In some embodiments, communication between a web browser application executing in the personal computer 13 and an e-commerce server 15 is protected from eavesdropping and tampering via standard cryptographic protocols, e.g. SSL/TLS.

The e-commerce server 15 provides offers to sell goods and/or services via application software executing in the e-commerce server. In some embodiments the application software consist of an HTTP (web) server with an associated database of offered goods and/or services.

Message flows 1a . . . 1z occur between the personal computer 13 and e-commerce server 15, in the act of providing the offer of goods and/or services to the user of personal computer 15. The nature of these message flows are not pertinent to the invention, but are typically a pre-requisite to arriving at a state where the user decides to effect a transaction.

Message 2 is the first message of a protocol exchange which effects a transaction. This message is initiated upon command by the user of the personal computer. For exemplary purposes, it is imagined that the user in this scenario desires to purchase a pair of shoes from the e-commerce retailer whose goods and services are offered for sale via ecommerce server 15. In some embodiments, Message 2 may take the form of an HTTP “POST” message, with associated detail information indicating the identity of the particular item(s) (e.g. pair of shoes) which are to be purchased. The information contained with Message 2 informs the e-commerce server of the user's banking identity, and the identity of the user's financial institution. This information allows the ecommerce server to identify the particular endpoint on network 16 to which a payment request is to be transmitted. Note that minimal “sensitive” information needs to be communicated at this point; the user's banking identity is insufficient information to allow another party to utilize said information for unauthorized purposes. The identity of the user's financial institution is likewise relatively nor sensitive information. In combination, these two items of information are still insufficient to allow another party to utilize said information for unauthorized purposes.

The e-commerce server forwards a payment request in the form of Message 3 to the user's financial institution via network 16. Included in Message 3 is the following information: a) The banking identity of the user desiring to effect a purchase; b) an identifying token by which the ecommerce server can correlate subsequent messages which are part of the same transaction (hereafter called the transaction token); c) a description of the particulars of the transaction (e.g. purchase of a particular pair of shoes, as identified by the user); d) the monetary amount of the transaction. Upon receipt of Message 3, the financial institution is now in possession of this same information. Note: Communications between the e-commerce server and the financial institution server are very likely to be cryptographically protected from eavesdropping and intrusion. However, such protection is outside the scope of this invention and not discussed or describe further.

The financial institution prepares Message 4 for transmission to the ecommerce server. At a minimum, the message includes the following data: a) the user's banking identity as provided in Message 2; b) the transaction token received from the e-commerce server in Message 3; c) the description of the particulars of the transaction as received from the e-commerce server in Message 3; d) the monetary amount of the transaction; e) an action code identifying the purpose of the message as “payment request”. Note that Message 4 is illustrated as a dashed line. This indicates that Message 4 is encrypted such that the message is unreadable by all entities except the authentication device 11 owned by the user effecting this transaction. Note, however, that the transaction token is not encrypted, as it is necessary for the e commerce server to be capable of reading this token so as to identify on behalf of which user (of any number of users currently involved in such transactions) this message is related.

Upon receipt of Message 4, the ecommerce server uses the transaction token to identify which communications session (via network 14 to one particular personal computer out of a possible multitude of such currently connected computers) to forward this message. Having so identified the particular session, the ecommerce server forwards this message, as Message 5, to the personal computer 13 of the user requesting this transaction. The portion of Message 4 which was encrypted by the financial institution server 17 is included in Message 5 in unaltered form.

The personal computer of the user requesting this transaction'receives Message 5, and must be capable of interacting with the authentication device 11 by way of software installed on the personal computer for this specific purpose. In some embodiments this will be a “plug-in” or “add-on” to the web browser software which the user is utilizing to perform the “online shopping” activity. Note that the nature of this additional software (and in fact that of the web browser software as well) is that it is of no importance if this software's integrity is compromised (e.g. trojan-horse, rootkit, key logging, etc.) as all of the sensitive information pertaining to the transaction is encrypted such that any such corruption of the personal computer's software is not capable of capturing or altering any of the sensitive information being exchanged.

The authentication device 11 receives Message 5 in its encrypted form. Its operating software verifies the origin of the encrypted contents of Message 5 as originating from the user's legitimate financial institution. The encrypted content are decrypted. The authentication device presents the user with information pertaining to the transaction (e.g. identity of merchant, identity of goods or services to be obtained, monetary amount of transaction) on the display 111 of the authentication device. If the authentication device is a multipurpose device wherein the authentication and identity function is a sub component of the multi-purpose device, it is necessary that the device possess a visual indicator which can only be operated by processing unit 114, and which, when activated, alerts the user of the authentication device that the information currently displayed on the authentication device display 111 is information being displayed by the authentication device and can therefore be accepted as genuine.

The user, having been offered the information pertaining to the current transaction, said information being either presented on a display which is dedicated to the invention's purpose, or which has been indicated as genuine via a dedicated visual indicator associated with said display, where said indicator can only be activated by processing unit 114, may choose to accept or decline the transaction. The user indicates this choice by operating an input mechanism which is the sole means of such indication of choice which may be submitted to processing unit 114. Given that this input mechanism is outside the control of any software executing in the personal computer, that malicious interference with the operation of the input mechanism can only be effected by direct mechanical modification of the device, and that the operating instructions which are the sole effector of the internal operation of the device 11, the processing unit 114 is capable of operating upon said user input as authoritative, and complete its role in the transaction processing as required.

Having presented transaction information to the user on display 111 of authentication device 11, and having obtained user input via input mechanism 112 of authentication device 11, the processing unit 114 constructs Message 7 for transmittal to the personal computer. As before, most of the message is encrypted such that only financial institution server 17 can decrypt and process the message. Further, the message is cryptographically signed such that alteration of the message contents by intermediate nodes in the communication path cannot be effected without rendering the message invalid upon arrival at financial institution server 17, the message is transmitted to personal computer 13.

Software in personal computer 13 forwards Message 7 as new Message 8, including the transaction token previously received as a component of message 5, to e-commerce server 15.

E-commerce server 15 prepares Message 9, including the contents of Message 8, and transmits this message to financial institution server 17.

Financial institution server 17 decrypts the encrypted portion of Message 8 (said encrypted portion having been constructed by authentication device 11), and processes the transaction request. The user will have indicated either approval or disapproval of the requested transaction.

Financial institution server 17 effects the requested action by generating Message 10, whereby le financial institution server either authorizes or declines the transaction, based firstly on the user's instructed action, and secondly (in the event the user approves the transaction) on the financial institution's willingness to release the monetary payment specified in the transaction.

Note that an alternative protocol behavior may be for the financial institution to deny this transaction in Message 4, on the basis that the user does not have sufficient authority or available funds to consummate the transaction. In such case, messages subsequent to Message 5 would not transpire, as there would be no need for any interaction with the authentication device 11.

The application described herein is exemplary of one of a multitude of possible use cases wherein an authentication device 11 and associated methods described herein may be employed to perform secure and protected transactions via insecure computing and communications mechanisms which are intermediate in the path of exchange of information between the authentication device 11 and service providers, such as financial institution server 17. This description is not meant to constrain the applicability of the invention to preclude any other such applications as may find benefiting use of the invention.

1. A device comprising: A display capable of providing the user with textual and/or graphic information pertaining to a transaction offered by a second party, an associated input mechanism by which the user can accept or reject the transaction presented on the associated display, a dedicated computational unit whose operating instructions are not alterable by any party other than those parties specifically authorized and empowered to alter said operating instructions by the manufacturer or authorized representative of the manufacturer, and an identity and associated secret key as well as a user-selected secret (e.g. PIN) stored securely within the device, where said identity, key, and user-selected secret are used to prove identity and authenticity of device.

2. The device of claim 1, wherein said display is dedicated to the said purpose, with the display not being capable of any purpose other than said purpose.

3. The device of claim 1, wherein said input mechanism is dedicated to the said purpose, with the input mechanism not being capable of any purpose other than said purpose.

4. The device of claim 1, wherein said display and input mechanisms may be used for purposes other than said purpose, but with said device possessing a distinct visual indication that indicates when said display and input mechanism are operating in the mode of said purpose.

5. The device of claim 1, wherein the dedicated computational unit performs cryptographic authentication and identification functions on behalf of the user, based on inputs from the second party requesting a transaction, and the user, by way of associated input mechanism, in response to presentation of transaction request on associated display.

6. The device of claim 1, wherein the performance of authentication and identification functions by the dedicated computational unit are directed to be so performed only by user input via the associated input mechanism.

7. The device of claim 1, wherein electronic interface into, and out of, the said device are via a protected electrical interface, wherein such protection prevents unauthorized disclosure of secret information stored internally to the dedicated computational unit, thereby allowing only publicly disclosable information and/or cryptographically protected private information to enter or leave said device.

8. The device of claim 1, wherein said device includes a . biometric input mechanism.

9. A method comprising: A protocol by which a second party may present a transaction to the device of claim 1 requesting authorization to perform said transaction on behalf of the user of said device, wherein said device validates authenticity of said transaction as originating from party (or agent thereof) presenting the transaction to said device, presents details of said transaction to user via display of said device, and receiving input accepting or rejecting transaction via input mechanism of said device, and approving or rejecting said transaction on the basis of such user input.

9. The method of claim 9 whereby the dedicated computational unit of said device creates an electronic message as response to a transaction request received from a second party, either accepting or declining the transaction, based on input from the user.

10. The method of claim 9 whereby transaction request information, presented by a second party, is graphically or textually represented on the display of the device, while said display is either dedicated to presentation of transaction information (as expressed in claim 2) or operating in a mode for display of said transaction, where said mode is visually indicated (as expressed in claim 3) in conjunction with presentation of transaction request information.

11. The method of claim 9 whereby the user may accept or decline the presented transaction request via associated dedicated input mechanism (as expressed in claim 3), or via associated shared input mechanism (as expressed in claim 4) where said shared input mechanism is indicated as operating in transaction mode by a distinct visual indication (as expressed in claim 4).

12. The method of claim 9 whereby the user's credentials are entered via user input of a secret (e.g. PIN or password).

13. The method of claim 9 whereby the user's credentials are entered via a biometric reading device.
